(19) United States
(12) Patent Application Publication
(10) Pub. No.: US 2016/0126001 A1
(43) Pub. Date: May 5, 2016

(54) WIRELESS CHARGING COIL PCB STRUCTURE WITH SLIT

(71) Applicant: TDK TAIWAN Corporation, Taipei City (TW)

(72) Inventors: Feng-Lung CHIEN, Yangmei Taoyuan (TW); Takahiro OISHI, Yangmei Taoyuan (TW); Chris T. BURKET, Yangmei Taoyuan (TW); Chao-Neen CHANG, Yangmei Taoyuan (TW); Alan WU, Yangmei Taoyuan (TW)

(21) Appl. No.: 14/605,570

(22) Filed: Jan. 26, 2015

(30) Foreign Application Priority Data
Oct. 31, 2014 (TW) 103137759

(51) Int. Cl. H01F 27/28; H02J 7/02

(52) U.S. Cl. CPC H01F 27/2804; H02J 7/025; H01F 2027/2809; H01F 2027/2819

(57) ABSTRACT

A wireless charging coil PCB structure with slit includes at least one coil is disposed on a printed circuit board (PCB), wherein a slit defined on a portion of the conductive wire of the coil. The slit is located at the center of the coil wires and extending parallel to the conductive wire of the coil to increase the distance between the coil turns of the wire winding, and to overcome the proximity effect between the coil wires, and to reduce the coil impedance as well as enhance the heat dissipation effect.

### BACKGROUND OF THE INVENTION

1. Field of the Invention

The present invention relates to a wireless charging coil PCB structure with slit, more particularly to a wireless charging coil PCB structure for overcoming the proximity effect between coils.

2. Description of the Prior Art

Wireless Charger (WLC) is a cordless power transmission technology using electromagnet induction. FIG. 1 is a schematic diagram showing the wireless charging scheme. The shown wireless charging scheme comprises a power transmitting module 10 and a power receiving module 20. The power transmitting module 10 comprises a transmitting-end coil 11 and a transmitting-end ferrite plate 12. The power receiving module 20 correspondingly comprises a receiving-end coil 21 and a receiving-end ferrite plate 22. When the power receiving module 20 is in proximity of the power transmitting module 10 and electrical current flows through the transmitting-end coil 11 to generate magnetic field, the receiving-end coil 21 of the power receiving module 20 will generate electrical current induced by the magnetic field.

The high end WLC module has plate with larger size at the power transmitting-end such that the power receiving module can be successfully charged as long as it is close to the plate of the power transmitting-end. Therefore, the power transmitting module will arrange lots set of coils to cover the desired charging range. For example, two sets of coils, or even three sets of coils may be arranged.

The turn number and the coil inductance are related to the transmitting frequency of wireless charging and a non-coil region is formed at the center of the coil, therefore, another set of coil is generally arranged on the top of one set of coil. FIG. 2 shows the schematic view of a prior art inductor plate 12 with two sets of coils, where the coil 11 is arranged on top face of the inductor plate 12 and another coil 11′ is arranged on bottom face of the inductor plate 12. Part of the coil 11 on top face of the inductor plate 12 has a projection on the non-coil region 13′ of the coil 11′ on bottom face; and part of the coil 11′ on bottom face of the inductor plate 12 has a projection on the non-coil region 13 of the coil 11 on top face.

FIG. 3 shows the schematic view of another prior art inductor plate 12 with three sets of coils, and FIG. 4 shows the sectional view of the inductor plate 12 in FIG. 3. The three sets of coils are arranged in three overlapped rectangular manner. Namely, the coil 11′ on top face of the inductor plate 12 has a projection at the center between two other coils 11″ on bottom face of the inductor plate 12, and a part of the coil 11′ on top face of the inductor plate 12 has a projection on the non-coil region 13 of the other two coil 11″ on bottom face of the inductor plate 12. Similarly, more sets of coils such as four, five or even more sets of coils can be arranged in way similar to those shown in FIGS. 3 and 4, and the detailed description is omitted here for brevity.

In the inductor plate 12 shown in FIG. 4, the stacked coils are generally manufactured with multi-layer printed circuit board to reduce the overall height of the inductor plate 12. The inductor plate 12 for mounting the three coils 11′, 11″ is arranged on a ferrite plate 14 and is covered with a top plate, resulting in a WLC plate structure with at least four layers.

The high-end WLC module has higher demands for transmitting efficiency and heat dissipation ability; therefore, the coil impedance should be accordingly low for the PCB. However, the WLC module uses high frequency alternating current (AC) and the transmitting efficiency is related to the coil frequency and the matching of inductance. Coil impedance will increase and inductance will have fluctuation if proximity effect occurs between coils close to each other or between upper and lower stacked coils. Moreover, heat dissipation effect is also degraded. These are drawbacks to be overcome for high-end WLC module.

### SUMMARY OF THE INVENTION

It is an object of the present invention to provide a wireless charging coil PCB structure to overcome the proximity effect occurs between coils close to each other. Accordingly, the wireless charging coil PCB structure according to the present invention comprises at least one coil arranged on a printed circuit board (PCB), at least a portion of conductive wire of the coil having a slit, the slit defined on a center portion of the conductive wire and extended parallel with the conductive wire of the coil.

According to another aspect of the present invention, the coils can be arranged on a single layer, top/bottom layers or inter-layer of the PCB. The slit can be defined on almost entire conductive wire of the coil except two terminal ends of the conductive wire; or defined on non-corner conductive wire of the coil.

According to still another aspect of the present invention, the conductive wire of the coil on one layer has a projection on another layer, and the projection passes a center non-coil region of another coil on another layer, whereby the coils on the two layers have crossed projections with each other.

According to still another aspect of the present invention, the coil on the bottom layer or inter-layer of the PCB has conductive wires passing the PCB and extending to the top layer of the PCB, the extending conductive wire is arranged on a non-coil region on the top face, wherein the conductive wire of the coil on the top layer is not present on the non-coil region on the top layer.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram showing the wireless charging scheme.

FIG. 2 shows the schematic view of a prior art inductor plate with two sets of coils.

FIG. 3 shows the schematic view of another prior art inductor plate with three sets of coils.

FIG. 4 shows the sectional view of the inductor plate in FIG. 3.

FIG. 5 shows the top view of the PCB structure with a coil according to an embodiment of the present invention.

FIG. 6 shows the top view of the PCB structure with four coils arranged on a PCB according to another embodiment of the present invention.

FIG. 7 shows a partially enlarged view at corner portion of the coil, where the slit is defined on the non-corner portion of the conductive wires of the coil.

FIG. 8A shows the top view of the PCB structure with three coils according to another embodiment of the present invention.

FIG. 8B shows the bottom view of the PCB structure in FIG. 8A.

FIG. 8C shows the section view of PCB structure in FIG. 8A.

FIG. 9 shows the section view of the PCB structure with three coils according to still another embodiment of the present invention.

FIG. 10A shows the top view of the of the two-layer PCB structure according to still another embodiment of the present invention.

FIG. 10B shows the bottom view of the of the two-layer PCB structure according to still another embodiment of the present invention.

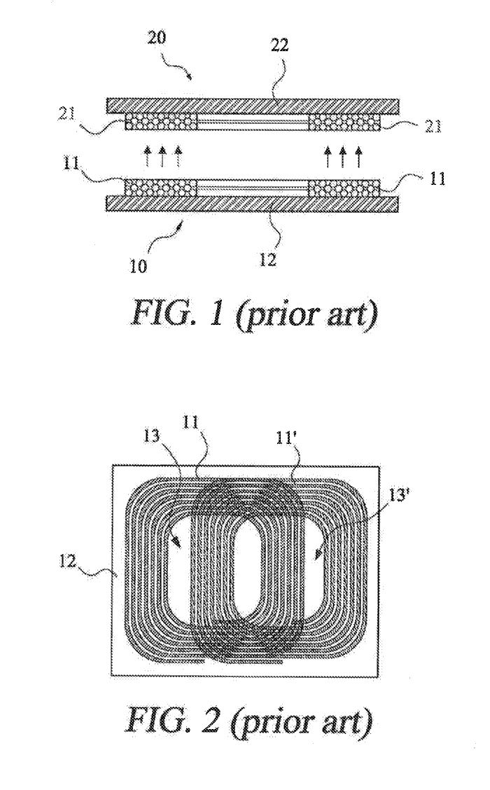

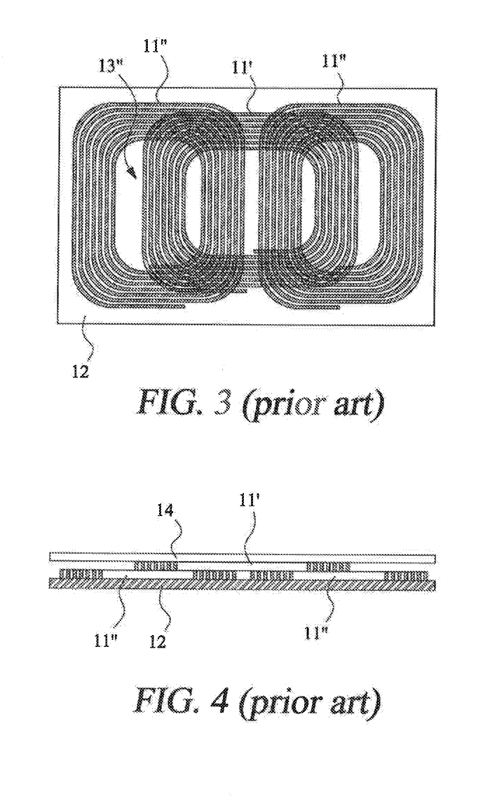

### DETAILED DESCRIPTION OF THE INVENTION

Hereinafter, the embodiments of the present invention will be described with reference to the associated drawings. It should be noted various exemplary embodiments shown in the figures are merely illustrative representations and are not necessarily the limit of the claim scope.

The present invention is intended to solve the problem of proximity effect occurring in PCB type coil of WLC module and reduce the coil impedance. The present invention can be applied to WLC module with varied number of coil and is not limited by following embodiments.

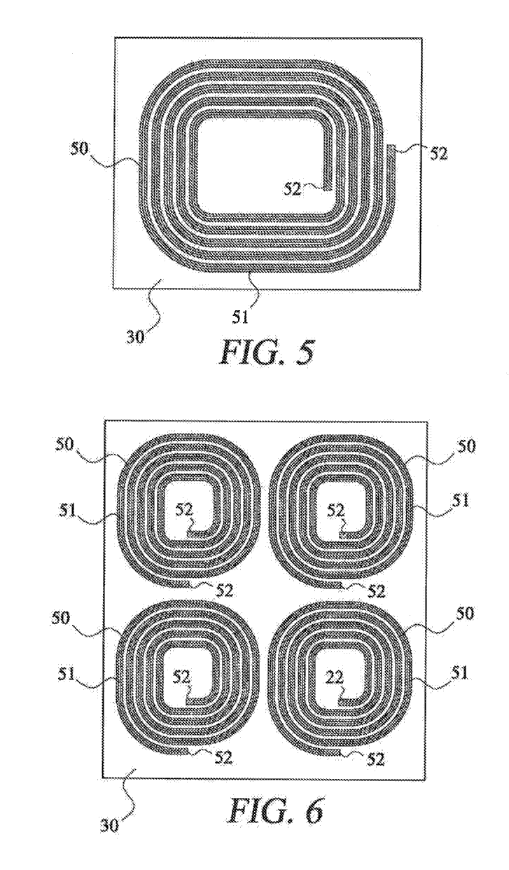

The present invention is first described with a single-layered PCB structure for wireless charging. FIG. 5 shows the top view of the PCB structure with a coil according to an embodiment of the present invention. The wireless charging coil PCB structure of the present invention comprises a coil 50 arranged on a PCB 30 and winds into concentric circle. The PCB 30 is arranged on a ferrite plate (not shown) to form a WLC induction board. The conductive wire of the coil 50 has a slit thereon. The slit is located on, for example, a center portion of the conductive wire of the coil 50 and extends parallel with the conductive wire. In this embodiment, the coil 50 can be wound into rectangular shape, circle shape, elliptic shape or polygonal shape. FIG. 6 shows the top view of the PCB structure with four coils 50 arranged on a PCB 30 according to another embodiment of the present invention. Similarly, the conductive wire of each coil 50 has a slit 51 thereon. The winding shape and size of the coils can be varied according to practical need and can be adapted according to the shape and size of PCB. Therefore, the winding shape and size of the coils are not limited by shown embodiments.

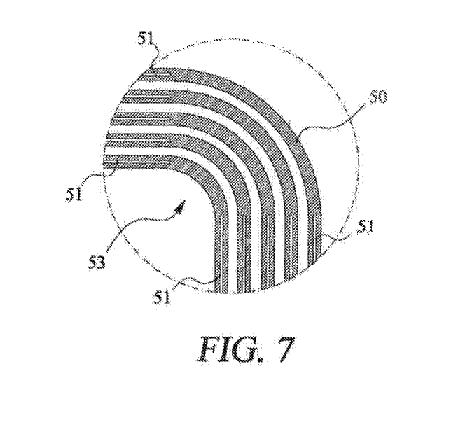

In the shown embodiment, the slit 51 defined on the conductive wire of the coil 20 can increase the winding distance of the coil 50 while the turn number of the coil 50 does not increase, thus reducing proximity effect, reducing AC (alternating current) impedance and enhancing the heat dissipation effect of coil. In the embodiments shown in FIGS. 5 and 6, the silt 51 is defined on almost along entire length of the coil 50 except the two terminal ends 52 of wire of the coil 50. FIG. 7 shows a partially enlarged view at corner portion of the coil, where the slit 51 is defined on the non-corner portion of the conductive wires of the coil. For example, the slit 51 is only present on the straight conductive wire of the coil 50 and is absent on the corner conductive wire 53 of the coil 50. The slit 51 needs not to be defined on the corner portion of the coil because the corner conductive wire has less proximity effect in comparison with the non-corner (such as straight) portion of the conductive wire.

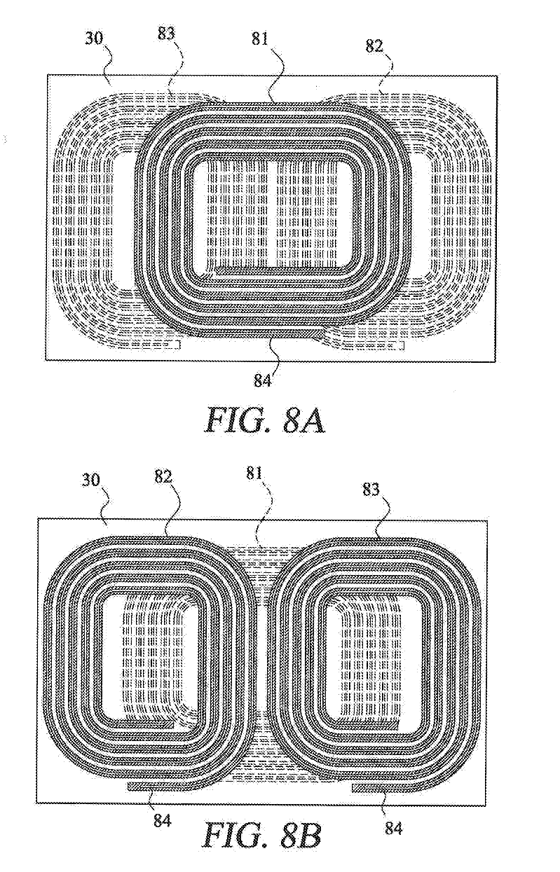

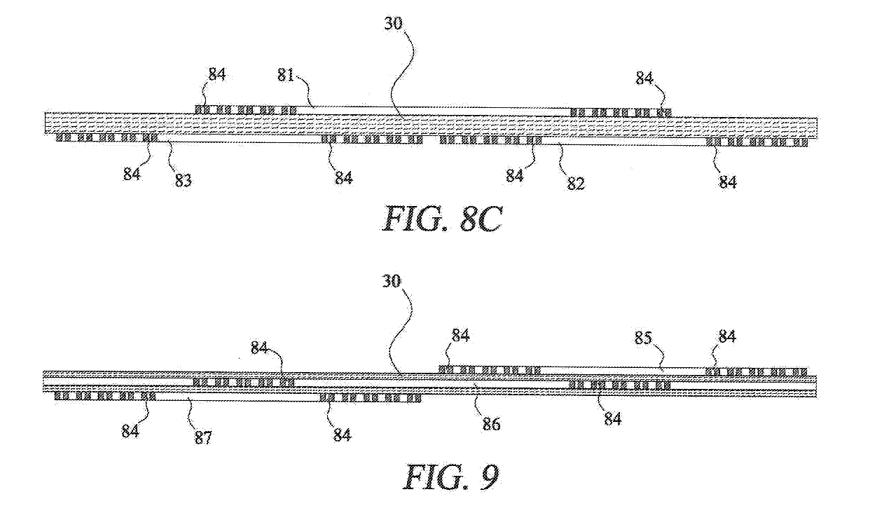

The present invention is then exemplified with two-layer wireless charging coil PCB structure. FIG. 8A shows the top view of the PCB structure with three coils according to another embodiment of the present invention. FIG. 8B shows the bottom view of the PCB structure in FIG. 8A and FIG. 8C shows the section view of PCB structure in FIG. 8A. There are three coils in the embodiment shows in FIGS. 8A-8C, where the first coil 31 is arranged on a first layer (first face) of the PCB 30, and the other two coils 82, 83 are arranged on a second layer (second face) of the PCB 30. The number, winding shape, size of the coils can be varied according to practical need and are not limited by shown embodiments. Similarly, the conductive wire of each of the coils 81-83 has a slit 84 defined on almost all portion of the coil except two terminal ends of the conductive wire of coil. Moreover, the slit 84 can be formed on non-corner conductive wire of the coils 81-83. In the embodiment shown in FIGS. 8A-8C, the slits 84 are defined on almost all portions of the coils except two terminal ends of each coil. Moreover, in the embodiment shows in FIGS. 8A-8C, the coil 81 on the first layer of the PCB is corresponding to a center position between two coils on the second layer of the PCB. Namely, the projection of the coil on the first layer is cross with the two coils on the second layer. Therefore, the projection of the coil of the first layer will pass the non-coil region of the two coils of the second layer, and the projections of the two coils of the second layer will also pass the non-coil region of the coil of the first layer. The wireless charging coil PCB structure can provide wireless charging from almost every portion on the PCB and there is no dead space on the PCB.

The present invention is then exemplified with multi-layer wireless charging coil PCB structure. FIG. 9 shows the section view of the PCB structure with three coils according to still another embodiment of the present invention. The first coil 85 is arranged on the topmost layer of the PCB 30, the second coil 86 is arranged on an inter-layer of the PCB, and the third coil 87 is arranged on the bottommost layer of the PCB 30. The number, winding shape, size of the coils can be varied according to practical need and are not limited by shown embodiments. Similarly, the conductive wire of each of the coils 85-87 has a slit 84 defined on almost all portion of the coil except two terminal ends of the conductive wire of the coil. Moreover, the slit 84 can be formed on non-corner conductive wire of the coils 85-87. The coil on one layer of the PCB (including the topmost layer, the inter-layer and the bottommost layer) has projection crossing the non-coil region of the other layer of the PCB (including the topmost layer, the inter-layer and the bottommost layer). In the embodiment shown in FIG. 9, the first coil 85 has projection on the inter-layer, and this projection passes the non-coil region of the second coil 36 on the inter-layer. The second coil 86 has projects on the topmost layer and the bottommost layer, and those projections pass the non-coil region of the first coil 85 on the topmost layer and the non-coil region of the third coil 87 on the bottommost layer. Similarly, the third coil 87 has projection on the inter-layer, and this projection passes the non-coil region of the second coil 86 on the inter-layer. The wireless charging coil PCB structure can provide wireless charging from almost every portion on the PCB and there is no dead space on the PCB.

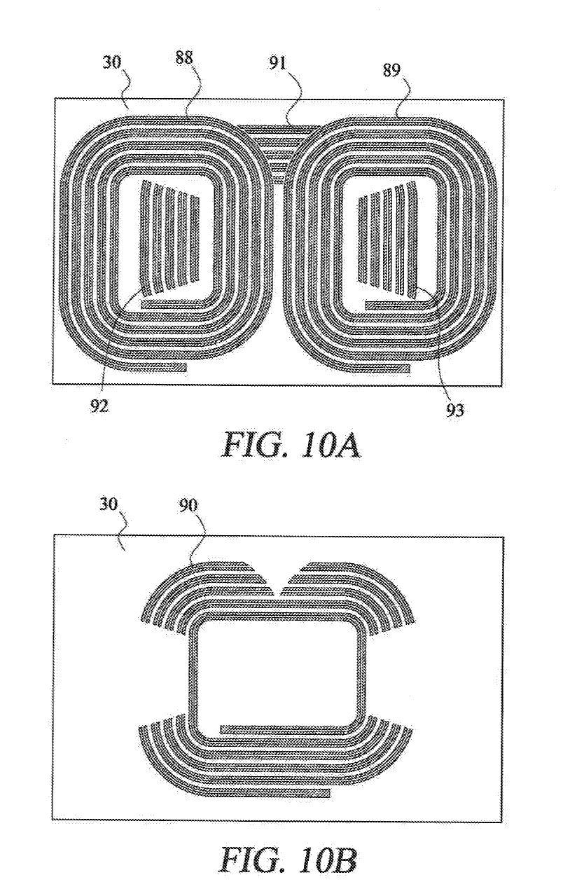

It is well-known that the power transmission loss is lower as the power transmitting end of the WLC induction board is closer to the power receiving end. The present invention further moves the coils on the inter-layer or bottommost layer in a two-layer or a multi-layer PCB to the topmost layer. FIG. 10A shows the top view of the of the two-layer PCB structure according to still another embodiment of the present invention. FIG. 10B shows the bottom view of the of the two-layer PCB structure according to still another embodiment of the present invention. As shown in FIGS. 10A and 10B, there are two coils 88 and 89 arranged on top layer of the PCB 30 and a coil 90 arranged on bottom layer of the PCB 30. A non-overlap region on the top layer is the region at centers (non-coil region) of the coils 88 and 89 and peripherals of the coils 88 and 89. The coil 90 on bottom layer has conductive wires passing the PCB 30 and extending to the non-overlap region of top layer of the PCB 30. As shown in FIG. 10A, the conductive wires 91 are arranged on peripheral of the coils 88 and 89. The conductive wires 92 are arranged on center non-coil region of the coil 88, and the conductive wires 93 are arranged on center non-coil region of the coil 89. Therefore, most of the conductive wires of all coils are arranged on the top layer of the PCB structure of the present invention to reduce the distance with the power receiving end, thus enhancing power transmission efficiency.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A wireless charging coil PCB structure, comprising:
at least one coil arranged on a printed circuit board (PCB), at least a portion of conductive wire of the coil having a slit, the slit defined on a center portion of the conductive wire and extended parallel with the conductive wire of the coil.

2. The wireless charging coil PCB structure in claim 1, wherein the coil is arranged on a single layer of the PCB.

3. The wireless charging coil PCB structure in claim 1, wherein the PCB structure has a plurality of coils and the coils are arranged on top layer and bottom layer of the PCB.

4. The wireless charging coil PCB structure in claim 3, wherein the PCB has an inter-layer and at least one coil is arranged on the inter-layer of the PCB.

5. The wireless charging coil PCB structure in claim 1, wherein the slit is defined on non-corner conductive wire of the coil.

6. The wireless charging coil PCB structure in claim 1, wherein the slit is defined on almost entire conductive wire of the coil except two terminal ends of the conductive wire.

7. The wireless charging coil PCB structure in claim 1, wherein the PCB is arranged on a ferrite plate.

8. The wireless charging coil PCB structure in claim 3, wherein the conductive wire of the coil on one layer has a projection on another layer, and the projection passes a center non-coil region of another coil on another layer, whereby the coils on the two layers have crossed projections with each other.

9. The wireless charging coil PCB structure in claim 4, wherein the conductive wire of the coil on one layer has projections on the other layers and one of the projection passes a center non-coil region of the coil on the other layer.

10. The wireless charging coil PCB structure in claim 1, wherein the coil is wound into rectangular shape, circle shape, elliptic shape or polygonal shape.

11. The wireless charging coil PCB structure in claim 3, wherein the coils have different sizes.

12. The wireless charging coil PCB structure in claim 3, wherein the at least one coil on the bottom layer of the PCB has conductive wires passing the PCB and extending to the top layer of the PCB, the extending conductive wire is arranged on a non-coil region on the top layer, wherein the conductive wire of the coil on the top layer ace is not present on the non-coil region on the top layer.

13. The wireless charging coil PCB structure in claim 12, wherein the non-coil region on the top layer is on a center or a peripheral of the coil on the top layer.

14. The wireless charging coil PCB structure in claim 4, wherein the at least one coil on the inter-layer of the PCB has conductive wires passing the PCB and extending to the top layer of the PCB, the extending conductive wire is arranged on a non-coil region on the top face, wherein the conductive wire of the coil on the top layer is not present on the non-coil region on the top layer.

15. The wireless charging coil PCB structure in claim 14, wherein the non-coil region on the top layer is on a center or a peripheral of the coil on the top layer.
